(19) United States
(12) Patent Application Publication
(10) Pub. No.: US 2013/0062854 A1
(43) Pub. Date: Mar. 14, 2013

(54) TORSION SUSPENSION SYSTEM

(71) Applicants: Gene M. Gorrell, Oswego, IL (US); Garrett V. Pommeranz, Plymouth, MN (US)

(72) Inventors: Gene M. Gorrell, Oswego, IL (US); Garrett V. Pommeranz, Plymouth, MN (US)

(73) Assignee: Caterpillar Inc., Peoria, IL (US)

(21) Appl. No.: 13/232,373

(22) Filed: Sep. 14, 2011

(51) Int. Cl. B60G 11/23

(52) U.S. Cl. 280/124.169

(57) ABSTRACT

A torsion suspension system of the present disclosure includes a vehicle frame and a bar group rotatably coupled to the vehicle frame. In an embodiment, the bar group includes a bolster tube. The bolster tube has an opening through an elongated side of the bolster tube. A torsion bar is positioned through the opening and has opposite ends extending outward of the opening. A plurality of elastomeric cords are positioned adjacent the torsion bar in the opening. The cords are sized to resist and dampen relative rotation between the opening and the torsion bar. The opposite ends of the torsion bar couple with the vehicle frame.

### TECHNICAL FIELD

The present disclosure relates generally to a torsion suspension system for a machine. In a specific embodiment, the present disclosure relates to a torsion suspension system for a rotary mixer machine, such as a road reclaimer.

### BACKGROUND

Machines are used today for many purposes. One such machine is known as a road reclaimer or rotary mixer. A rotary mixer machine generally has an appearance of a traditional road grader machine. However, instead of a passive grading blade found on a traditional road grader machine, the rotary mixer has a powered rotary cutter assembly that grinds up an existing road surface using revolving cutting rotor. This ground surface becomes a loose material that can be reclaimed and used in a new surface applied to the roadway.

As one can imagine, a machine of this type generates an amount of vibration during a normal course of operation. A portion of this vibration naturally travels through the body of the machine and to an operator of the machine. Such vibration may cause discomfort to the operator over time. Also, the machine will regularly traverse side-sloes during a normal course of travel, such as those created by crowned asphalt surfaces and banked curves. To reduce the transfer of vibration and to allow the machine's rear axle assembly to pivot when encountering side-slopes, traditional rotary mixers have a frame joined to a rear bolster assembly using a welded-in trunion and spherical plain bearings to allow the rear bolster assembly to oscillate back and fourth.

However, this type of trunion and bearing suspension is costly to produce and provides little vibration dampening. Thus, it is desirable to provide a system that improves upon these and other shortcomings of machine suspension systems.

### SUMMARY OF THE INVENTION

An embodiment of the present disclosure provides a torsion suspension system. The torsion suspension system includes a vehicle frame and a bar group rotatably coupled to the vehicle frame. In an embodiment, the bar group includes a bolster tube. The bolster tube has an opening through an elongated side of the bolster tube. A torsion bar is positioned through the opening and has opposite ends extending outward of the opening. A plurality of elastomeric cords are positioned adjacent the torsion bar in the opening. The cords are sized to resist and dampen rotation of the opening relative to the torsion bar. The opposite ends of the torsion bar couple with the vehicle frame.

Another embodiment of the present disclosure provides a vehicle with a torsion suspension system. The vehicle includes a frame, a power system, and a propulsion system. The propulsion system is coupled to the power system and configured to propel the frame. The vehicle also includes a torsion suspension system. The torsion suspension system includes a bar group rotatably coupled to the frame. In an embodiment, the bar group includes a bolster tube. The bolster tube has an opening through an elongated side of the bolster tube. A torsion bar is positioned through the opening and has opposite ends extending outward of the opening. A plurality of elastomeric cords are positioned adjacent the torsion bar in the opening. The cords are sized to resist and dampen rotation of the opening relative to the torsion bar. The opposite ends of the torsion bar couple with the frame.

Yet another embodiment of the present disclosure provides a rotary mixer machine with a torsion suspension system. The rotary mixer machine includes a frame, a power system, and a propulsion system. The propulsion system is coupled to the power system and configured to propel the frame. The rotary mixer machine also includes a rotary cutter assembly attached to the frame and positioned to cut a surface below the cutter assembly. Furthermore, the rotary mixer machine also includes a torsion suspension system. The torsion suspension system includes a vehicle frame and a bar group rotatably coupled to the vehicle frame. In an embodiment, the bar group includes a bolster tube. The bolster tube has an opening through an elongated side of the bolster tube. A torsion bar is positioned through the opening and has opposite ends extending outward of the opening. A plurality of elastomeric cords are positioned adjacent the torsion bar in the opening. The cords are sized to resist and dampen rotation of the opening relative to the torsion bar. The opposite ends of the torsion bar couple with the vehicle frame.

### BRIEF DESCRIPTION OF THE DRAWINGS

FIG. 1 illustrates a perspective view of an embodiment of a rotary mixer machine having a torsion suspension system according to the present disclosure.

FIG. 2 illustrates a perspective view of an embodiment of a portion of a frame, a rear bar group, and a wheel for the rotary mixer machine of FIG. 1.

FIG. 3 illustrates an enlarged perspective view of an embodiment of a rear portion of the frame, bar group, and wheel of FIG. 2 coupled together using a torsion suspension system according to the present disclosure.

FIG. 4 illustrates another perspective view of the bar group and wheel of FIG. 3 removed from the frame.

FIG. 5 illustrates an exploded perspective view of an embodiment of a torsion bar assembly according to the present disclosure.

### DETAILED DESCRIPTION

The present disclosure relates generally to a torsion suspension system for a machine. In a specific embodiment, the present disclosure relates to a torsion suspension system for a rotary mixer machine, such as a road reclaimer. While the following description relates to a rotary mixer machine, a person having ordinary skill in the art should readily understand that this torsion suspension system of the present disclosure may be adapted for various other machines and support structures.

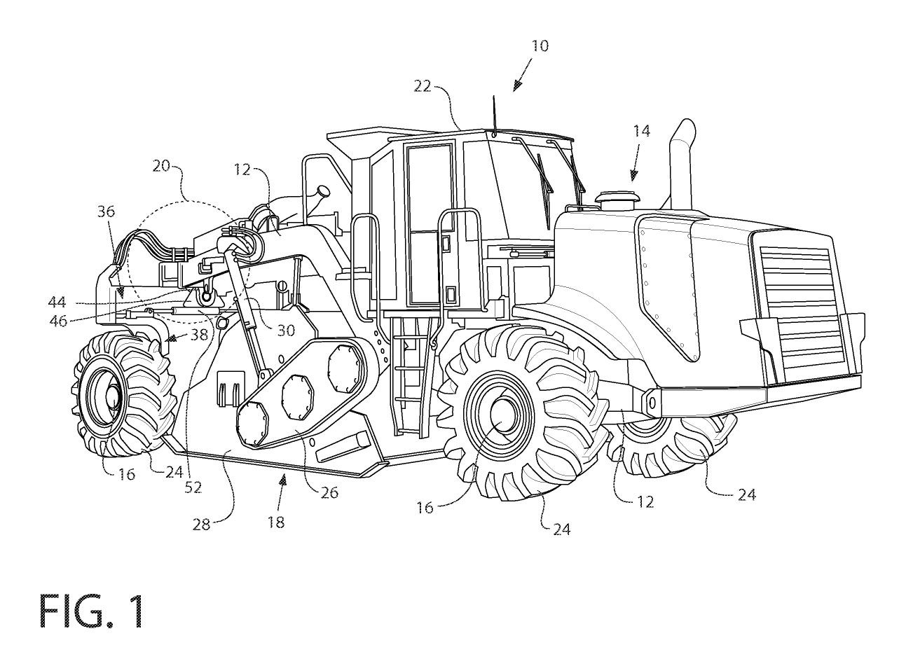

FIG. 1 illustrates a perspective view of an embodiment of a rotary mixer machine 10 having a torsion suspension system according to the present disclosure. For sake of brevity, the rotary mixer machine 10 is referred to as the machine 10 for the remainder of this document. The machine 10 is built upon a frame 12 and includes a power system 14, a propulsion system 16, a rotary cutter assembly 18, and an operator station 22.

The machine frame 12 is generally a rigid metal frame (e.g., iron, steel, etc.) configured to support the machine 10 and to withstand the vibrations of the machine 10. The frame 12 supports the power system 14 and a related cooling system (not shown). The power system 14 is operatively connected to the propulsion system 16 (e.g., transmission, hydraulic pump, hydraulic motors, etc.) to drive wheels 24 located on opposite sides of machine 10 for propulsion of the machine 10. The frame 12 may also support an operator station 22 for primary control of the machine 10 during operations of the machine 10.

Power system 14 is a propulsion system that includes an internal combustion reciprocating engine such as a diesel engine, a gasoline engine, a gaseous fuel (e.g., a natural gas) powered engine. In an alternative embodiment, the power system 14 may include a rotary engine, a turbine engine, a non-combustion source of power such as a fuel cell, a power storage device, an electric motor, or other type of power system.

To propel the machine 10, the propulsion system 16 includes a hydraulic or an electric drive (not shown). For example, power system 14 may be operatively connected to a pump (not shown), such as a variable or fixed displacement hydraulic pump. The pump may produce a stream of pressurized fluid directed to one or more motors (not shown) associated with wheels 24 for the primary means of propulsion. Alternatively, power system 14 may be drivably connected to an alternator or generator (not shown) configured to produce an electrical current used to power one or more electric motors (not shown) for driving the wheels 24.

In an alternative embodiment, power system 14 may be operatively coupled with wheels 24 using a transmission (not shown), torque converter (not shown), gear box (not shown), transfer case (not shown), differential (not shown), drive shaft (not shown), reduction gear arrangement, and/or any other devices configured to transmit power from power system 14 to the wheels 24.

In addition to driving the wheels 24, power system 14 may be configured to supply power to the rotary cutter assembly 18 employed by the machine 10 to penetrate and grind a surface, such as a road surface, and/or to perform other operations. For example, in one embodiment, a transmission (not shown) is connected to a drive system 26 via one or more chains, belts, pulleys, and/or a variety of other features (not shown) to turn a rotary cutter (not shown), which is located below the frame 12, between front and rear wheels 24, inside a frame 28. In an alternative embodiment, the transmission (not shown may be connected to a fluid pump (not shown). The pump may be fluidly connected through one or more supply and/or return lines (not shown) to supply a flow of pressurized fluid to a hydraulic motor (not shown), which is in turn operatively connected to power the rotary cutter assembly 18. The rotary cutter assembly 18 may be raised and lowered using one or more hydraulic cylinders such as cylinder 30 coupled between the frame 12 and the rotary cutter assembly 18.

The operator station 22 is an enclosed cab having an operator seat (not shown) and operating controls (not shown) for controlling operations of the machine 10. An operator may control operations of the machine 10 from the operator station 22. In an alternative embodiment, the operator station 22 may be a canopy (not shown), an open cab (not shown), a remote control computer station (not shown), an autonomous control computer station (not shown), or other type of control station.

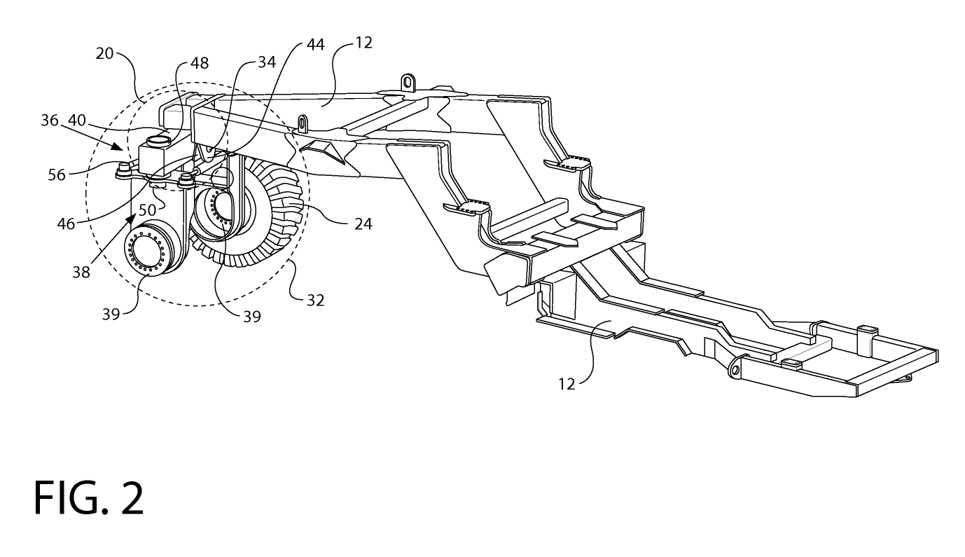

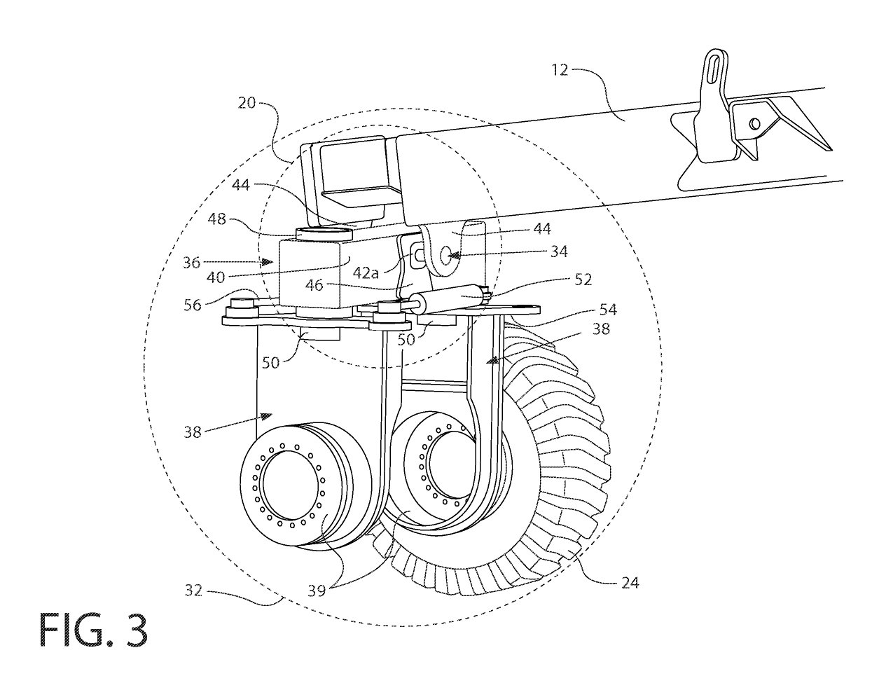

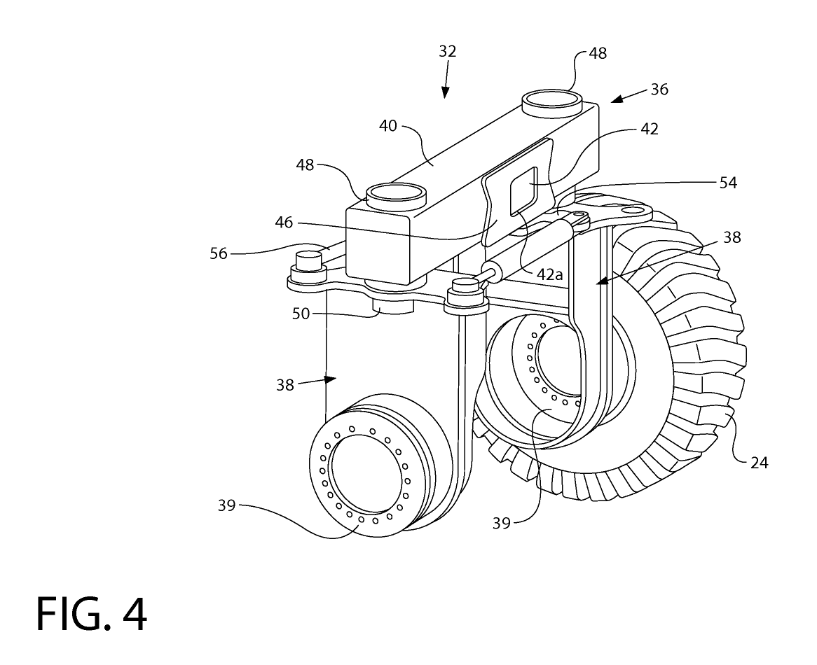

FIG. 2 illustrates a perspective view of an embodiment of a portion of the frame 12 and a rear bar group 32 for the machine 10. FIG. 3 illustrates an enlarged perspective view of an embodiment of a rear portion of the frame 12 and the bar group 32 coupled together using a torsion suspension bar assembly 34 according to the present disclosure. FIG. 4 illustrates another perspective view of the bar group 32 removed from the frame 12.

The bar group 32 includes a bolster assembly 36 coupled with a pair of opposite pillar assemblies 38. The bolster assembly 36 couples the bar group 32 to the frame 12 via the torsion suspension system 20. The pillar assemblies 38 support the wheels 24 and part of the propulsion system 16 via axle housings 39 for supporting and propelling the machine 10.

The bolster assembly 36 includes a bolster tube 40. The bolster tube 40 is an elongated rigid steel support member. However, in other embodiments, the bolster tube 40 may be formed from other materials. An opening 42 is formed through a side of the bolster tube 40. The torsion suspension bar assembly 34 passes through the opening 42 and mates with a pair of bolster connection plates 44 at opposite ends of the torsion suspension bar assembly 34, which is located through the opening 42 in the bolster tube 40. As such, the bar group 32 is rotatably coupled to the frame 12 about a central longitudinal axis of the torsion suspension bar assembly 34.

The bolster tube 40 may include one or more gusset plates 46 affixed to the bolster tube 40 to provide rigidity support to the bolster tube 40. In an embodiment, the gusset plates 46 are formed of steel and welded to the bolster tube 40 proximate the opening 42. The gusset plates 46 include an opening 42a that corresponds with the opening 42 in the bolster tube 40.

In addition to supporting the machine 10, the bar group 32 accommodates steering of the machine 10. Spindle housings 48 through the bolster tube 40 concentrically mate with spindles 50 attached to the pillar assemblies 38. The spindles 50 are configured to rotate in the spindle housings 48, thereby causing the wheels 24 attached to the pillar assemblies 38 to turn. Hydraulic cylinders 52 mounted between the pillar assemblies 38 and the steering plate 54 provide the moving force to rotate the spindles 50 in the spindle housings 48. A tie rod 56 ties opposite pillar assemblies 38 together to cause both pillar assemblies 38 and correspondingly both wheels 24 to turn substantially the same amount.

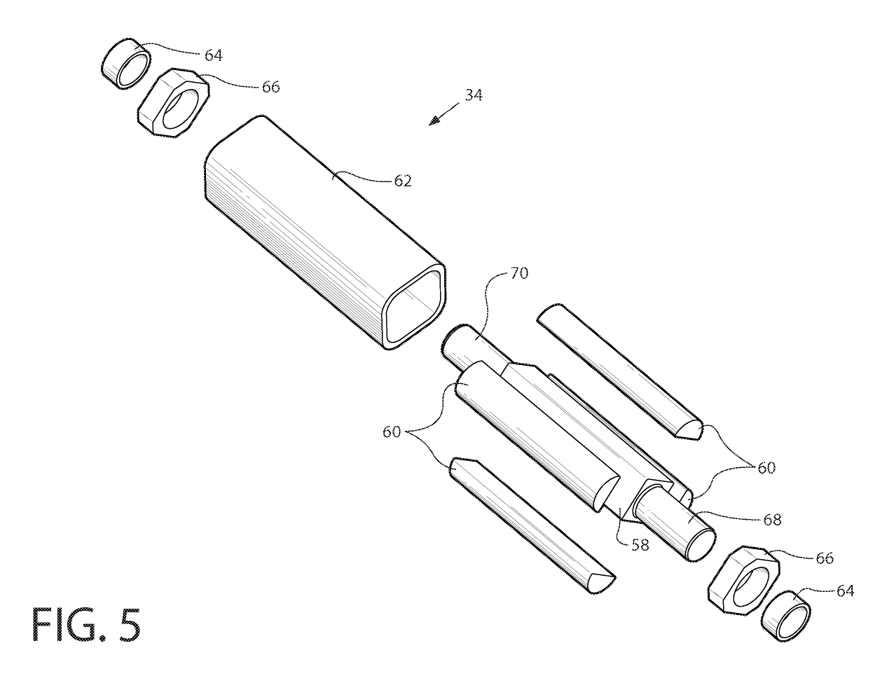

FIG. 5 illustrates an exploded perspective view of an embodiment of the torsion bar assembly 34 according to the present disclosure. The torsion bar assembly 34 includes a torsion bar 58, a plurality of elastomeric cords 60, an outer tube 62, a pair of bushings 64, and a pair of locking collars 66.

The outer tube 62 is a hollow rigid tube configured to mate through the opening 42 in the bolster tube 40 and also to receive the torsion bar 58 and the elastomeric cords 60. In an embodiment, the outer tube 62 is welded to the opening 42a of the gusset plate 46 before the elastomeric cords 60 are inserted into the outer tube 62 so that the welding will not damage the elastomeric cords 60.

The elastomeric cords 60 are formed of rubber, silicone, polymer, or other elastomeric material. The elastomeric cords 60 facilitate the resistance to the allowed rotation and are sized to naturally deform and limit rotation of the torsion bar 58 relative to the outer tube 62 and/or the opening 42 in the bolster tube 40 and to elastically recover back into their original shape as the oscillating assembly returns to its neutral position. In other words, the elastomeric cords 60 are sized to resist the allowed rotation of the opening 42 relative to the torsion bar 58, which serves to dampen, or “cushion” the severity of the axle rotation that is felt by the operator. In an embodiment, a maximum rotation of the bolster tube 40 is limited by steel stops (not shown) that the bolster tube 40 contacts on the frame 12.

The bushings 64 are formed from a low friction material and form a bearing surface for opposite ends 68, 70 of the torsion bar 58 passing through the locking collars 66. The locking collars 66 are formed from a rigid material and may be semi-permanently attached holding the torsion bar 58 in place in the outer tube 62. However, the locking collars 66 may be removed to allow replacing the elastomeric cords 60.

The torsion bar 58 is formed of a rigid material such as tempered steel. However, other materials may be used for the torsion bar 58. The shape and orientation of the torsion bar 58 (e.g., shown square but can be other shapes) is such that the elastomeric cords 60 fit in openings between the torsion bar 58 and the outer tube 62. The opposite ends 68, 70 of the torsion bar 58 rigidly mate with corresponding openings (e.g., shown circular/cylindrical but can be other shapes) in the bolster connection plates 44. The rigid mating of the ends 68, 70 with the bolster connection plates 44 may be facilitated by the shape of the corresponding parts, by welding, by fastening, or by other means such that the ends 68, 70 do not rotate or substantially do not rotate in the mounting holes of the bolster connection plates 44.

Accordingly, as the machine 10 travels over bumps and holes the outer tube 62/opening 42 rotates back and forth with the bar group 32 when the rear wheels 24 engage bumps or holes while the torsion bar 58 remains rigid with the frame 12 via the bolster connection plates 44. As such, the elastomeric cords 60 flex in the openings between the outer tube 62 and the torsion bar 58 and thus resist and dampen rotation of the outer tube 62 and/or opening 42 relative to the torsion bar 52. In other words, rotation relative to the torsion bar 58 and the outer tube 62 is resisted by the elastomeric cords 60, which are fixed with respect to the outer tube 62 and exert a biasing torque on the torsion bar 58.

In another embodiment, the torsion suspension system 20 of the present disclosure may be formed without the outer tube 62. In this embodiment, the opening 42 in the bolster tube 40 is sized and shaped to directly receive the torsion bar 58 and the elastomeric cords 60. As such, the opening 42 performs the functions of the outer tube 62 as described herein.

In an embodiment, the outer tube 62, the torsion bar 58 and the elastomeric cords 60 are sized such that there may be a rotational oscillation of the bar group 32 of up to approximately +/−8.5° from the resting plane of the machine 10. However, the systems of the present disclosure may be formed to allow other rotational specifications.

### INDUSTRIAL APPLICABILITY

As should be understood, the present disclosure is directed toward an improved axle suspension for a machine, such as road reclaimer. In particular, this disclosure relates to an axle suspension via an elastomeric torsion spring. In an effort to improve the ride comfort of operators, engineers seek to limit vibrations from the ground from reaching the operator.

Traditional machines of this type feature an oscillating rear axle that is a rigid pin and bearing with a steel plate that limits travel of the axle to a predetermined angle. In contrast, the present disclosure seeks to improve the shock absorption by including a rubber torsion spring to support the rear axle and offer suspension benefits. In an embodiment, the cross section of the present disclosure is a square bar inside a square tube with four rubber cords under load separating the two. This design may replace the expensive pin and spherical bearing combination of the traditional machines. The new design allows oscillation of the rear axle to a preset amount of degrees while also absorbing the effects of rough terrain. In other words, the new design would allow the axle to pivot about its center such that one wheel can be higher than the other wheel at a given time when varying bumps or “side” slopes are encountered. As such this, thereby reduces vibration that is transmitted to the operator of the machine when operating the machine such as cutting asphalt or stabilizing soil.

While aspects of the present disclosure have been particularly shown and described with reference to the embodiments above, it will be understood by those skilled in the art that various additional embodiments may be contemplated by modification of the disclosed machines, systems and methods without departing from the spirit and scope of what is disclosed. Such embodiments should be understood to fall within the scope of the present invention as determined based upon the claims below and any equivalents thereof.

What is claimed is:

1. A torsion suspension system comprising:
a vehicle frame; and
a bar group rotatably coupled to the vehicle frame, the bar group including;
a bolster tube, the bolster tube having an opening through an elongated side of the bolster tube;
a torsion bar positioned through the opening and having opposite ends extending outward of the opening; and
a plurality of elastomeric cords positioned adjacent the torsion bar in the opening, the cords sized to resist and dampen rotation of the opening relative to the torsion bar, wherein the opposite ends of the torsion bar couple with the vehicle frame.

2. The torsion suspension system of claim 1, further comprising an outer tube located around the torsion bar and the plurality of elastomeric cords inside the opening.

3. The torsion suspension system of claim 1, wherein the torsion bar is positioned in the opening substantially perpendicular to the elongated side of the bolster tube.

4. The torsion suspension system of claim 1, wherein the vehicle frame has a pair of bolster connection plates extending from the frame to couple with the opposite ends of the torsion bar.

5. The torsion suspension system of claim 4, wherein the bolster tube is positioned such that rotation of the bolster tube about the torsion bar is substantially perpendicular to a longitudinal portion of the vehicle frame.

6. The torsion suspension system of claim 1, further comprising a set of drive wheel pillar assemblies extending from opposite ends of the bolster tube.

7. The torsion suspension system of claim 6, wherein the set of drive wheel pillar assemblies extend rotatably from the opposite ends of the bolster tube, and the torsion suspension system further comprising a steering system coupled between the set of drive wheel pillar assemblies.

8. A vehicle with a torsion suspension system, the vehicle comprising:
a frame;
a power system;
a propulsion system coupled to the power system and configured to propel the frame; and
a torsion suspension system, the torsion suspension system including;
a bar group rotatably coupled to the vehicle frame, the bar group including;
a bolster tube, the bolster tube having an opening through an elongated side of the bolster tube;
a torsion bar positioned through the opening and having opposite ends extending outward of the opening; and
a plurality of elastomeric cords positioned adjacent the torsion bar in the opening, the cords sized to resist and dampen rotation of the opening relative to the torsion bar, wherein the opposite ends of the torsion bar couple with the frame.

9. The vehicle of claim 8, further comprising an outer tube located around the torsion bar and the plurality of elastomeric cords inside the opening.

10. The vehicle of claim 8, wherein the torsion bar is positioned in the opening substantially perpendicular to the elongated side of the bolster tube.

11. The vehicle of claim 8, wherein the bolster tube is positioned such that rotation of the bolster tube about the torsion bar is substantially perpendicular to a longitudinal portion of the frame.

12. The vehicle of claim 8, wherein the propulsion system includes hydraulically actuated motors for propelling the frame.

13. The vehicle of claim 8, wherein the torsion suspension system is located at a rearward position of the vehicle.

14. The vehicle of claim 13, wherein the torsion suspension system provides steering for the vehicle.

15. A rotary mixer machine with a torsion suspension system, the rotary mixer machine comprising:
a frame;
a power system;
a propulsion system coupled to the power system and configured to propel the frame;
a rotary cutter assembly attached to the frame and positioned to cut a surface below the cutter assembly; and
a torsion suspension system, the torsion suspension system including;
a bar group rotatably coupled to the vehicle frame, the bar group including;
a bolster tube, the bolster tube having an opening through an elongated side of the bolster tube;
a torsion bar positioned through the opening and having opposite ends extending outward of the opening; and
a plurality of elastomeric cords positioned adjacent the torsion bar in the opening, the cords sized to resist and dampen rotation of the opening relative to the torsion bar, wherein the opposite ends of the torsion bar couple with the frame.

16. The rotary mixer machine of claim 15, further comprising an outer tube located around the torsion bar and the plurality of elastomeric cords inside the opening.

17. The rotary mixer machine of claim 15, wherein the torsion bar is positioned in the opening substantially perpendicular to the elongated side of the bolster tube.

18. The rotary mixer machine of claim 15, wherein the bolster tube is positioned such that rotation of the bolster tube about the torsion bar is substantially perpendicular to a longitudinal portion of the frame.

19. The rotary mixer machine of claim 15, wherein the rotary cutter assembly is positioned along the frame between the power system and the torsion suspension system.

20. The rotary mixer machine of claim 15, wherein the torsion suspension system provides steering for the rotary mixer machine.
